(19) United States
(12) Patent Application Publication
(10) Pub. No.: US 2010/0333066 A1
(43) Pub. Date: Dec. 30, 2010

(54) METHOD AND SYSTEM FOR MANAGING SOFTWARE ISSUES

(75) Inventors: Ashley Nathan Feniello, Woodinville, WA (US); David Abzarian, Kirkland, WA (US); Todd L. Carpenter, Monroe, WA (US); Didier Coussemaeker, Seattle, WA (US); Adrien Felon, Seattle, WA (US); Joe Futty, Sammamish, WA (US); Danny Lange, Sammamish, WA (US); Nicolas Mai, Seattle, WA (US); Graham Arthur Wheeler, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/491,435

(22) Filed: Jun. 25, 2009

(51) Int. Cl. G06F 9/44

(52) U.S. Cl. 717/120

(57) ABSTRACT

A method of managing software issues includes receiving issue data from a remote host, where the issue data is related to an issue associated with a software application installed on the remote host. The method identifies a potential solution for the issue and sends solution data to the remote host, where the solution data is related to the identified potential solution. Feedback data may be received from the remote host, where the feedback data is indicative of a degree to which the identified potential solution was effective in resolving the issue.

### TECHNICAL FIELD

The present application relates generally to electronic data management and, more specifically, to a method and system for managing software issues.

### BACKGROUND

Computing devices, and particularly mobile computing devices, are becoming more and more diverse, varying greatly from their form factor and processing capabilities to screen size and system memory. This diversity in computing devices may pose a range problems for software providers such as software vendors and software developers. In particular, providing software that will work on a variety of devices is becoming increasingly challenging, because different hardware, operating systems, etc. of the different devices, for example, may present unforeseen issues with software application that were designed for a specific run-time. As a result, it is becoming more common for software applications that were designed for a given set of devices to crash, or generally encounter issues on devices of other types.

Consequently, a mechanism that automatically catches and fixes issues without necessarily identifying all devices and operating conditions that a piece of software may encounter may be useful In particular, it may be desired that such a mechanism be configured to collect feedback from end users relating to different issues, provide solutions to those issues, or perform any combination thereof. Additionally, it may be helpful to provides users with some sort of a catalog that includes information regarding the different issues, solutions and combinations thereof.

### BRIEF DESCRIPTION OF THE DRAWINGS

FIG. 1A illustrates an example computer network;

FIG. 1B illustrates an example computer that may be connected to the network of FIG. 1A;

FIG. 2 illustrates an example software issue management environment;

FIG. 3 is a block diagram of an example software issue management system;

FIG. 4 illustrated an example issue database entry for a given software application;

FIG. 5 is a flow diagram of an example method 500 for managing software issues; and

FIG. 6 is a block diagram of an example host 600 that includes a virtual machine.

### SUMMARY

The present disclosure provides techniques for managing software issues.

In one embodiment, a computer program product includes a computer-usable medium having a computer-readable program code embodied therein. The computer-readable program code is adapted to be executed to implement a method of managing software issues on multiple hosts. The method may include receiving first issue data related to a first software issue with a software application installed on a first remote host, where the first issue data identifies one or more operating parameters associated with the first software issue. The method may further include determining a solution for the first software issue and solution data maybe provided related to the determined solution for the first software issue to the first remote host. The method may further includes receiving feedback data from the first remote host, where the feedback data indicates whether the determined solution was effective in fixing the first software issue. The method further includes receiving second issue data related to a second software issue with the software application installed on a second remote host, wherein the first issue data identifies one or more operating parameters associated with the second software issue. The method may further include providing the solution data to the second remote host if the one or more operating parameters associated with the first software issue and the one or more operating parameters associated with the second software issue include at least one common operating parameter, and if the feedback data from the first remote host indicates that the solution was effective in fixing the first software issue.

In another embodiment, a system includes a software issue processing system having a computer-readable program code embodied therein. The computer-readable program code may be adapted to be executed on a processor to receive issue data from a plurality of remote hosts, where the issue data is related to a plurality of issues associated with a software application installed on each the plurality of remote hosts. The computer-readable program code may be further adapted to be executed on a processor to identify a common issue among the plurality of issues, wherein the common issue is associated with a subset of the plurality of hosts of a particular host type. The computer-readable program code may be further adapted to be executed on a processor to associate the common issue with the particular host type. The system may further include a software catalog system having a computer-readable program code embodied therein, the computer-readable program code adapted to be executed on the processor to provide a user with information regarding the common issue and the associated host type.

In another embodiment, computer program product includes a computer-usable medium having a computer-readable program code embodied therein. The computer-readable program code may be adapted to be executed to implement a method of managing software issues on multiple hosts. The method may include receiving issue data from a remote host, where the issue data is related to an issue associated with a software application installed on the remote host. The method may further include identifying a potential solution for the issue. The method may further include sending solution data to the remote host, where the solution data is related to the identified potential solution. The method may further include receiving feedback data from the remote host, where the feedback data is indicative of a degree to which the identified potential solution was effective in resolving the issue.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the disclosed functionality and many of the disclosed principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

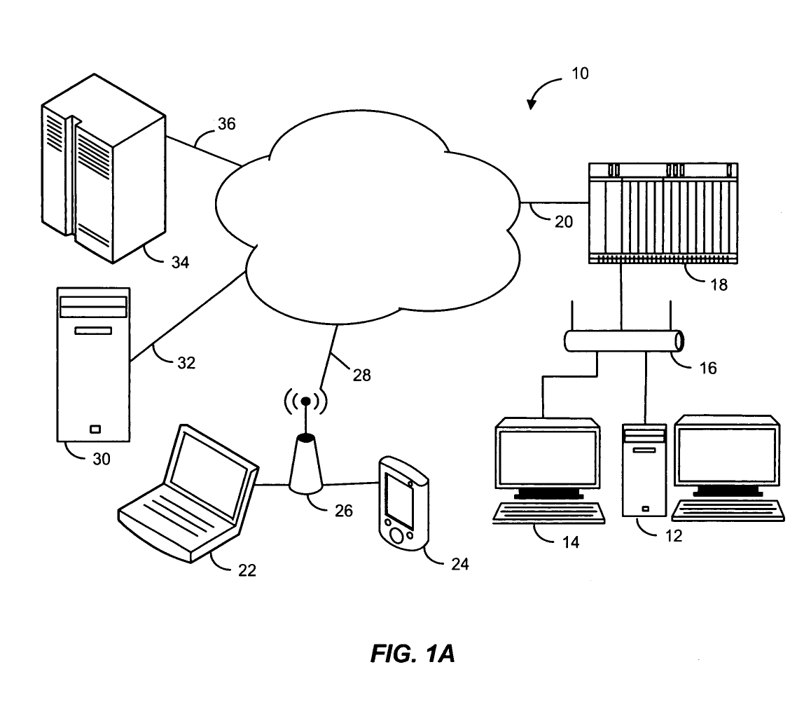

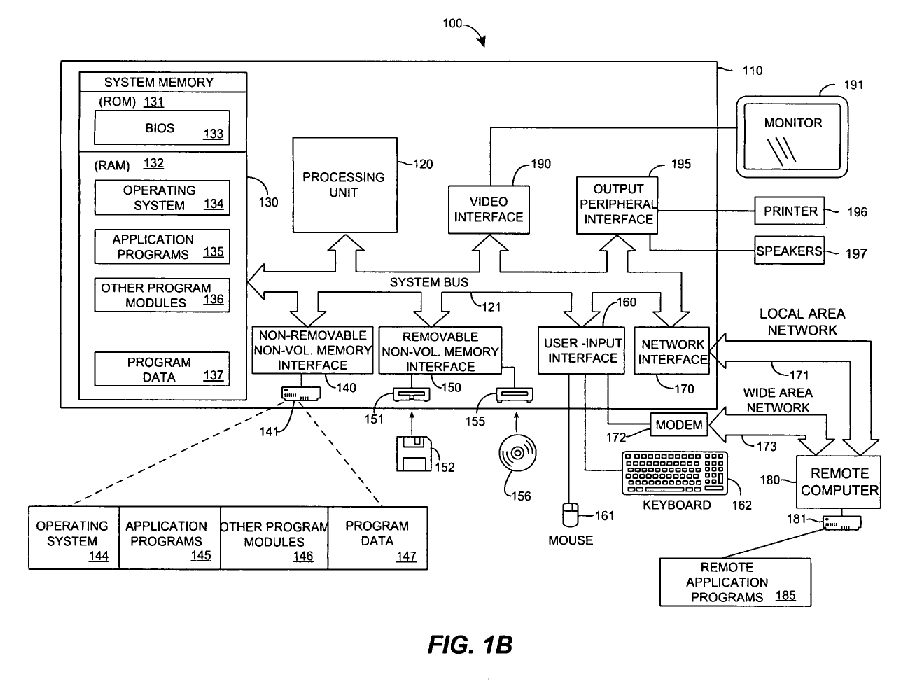

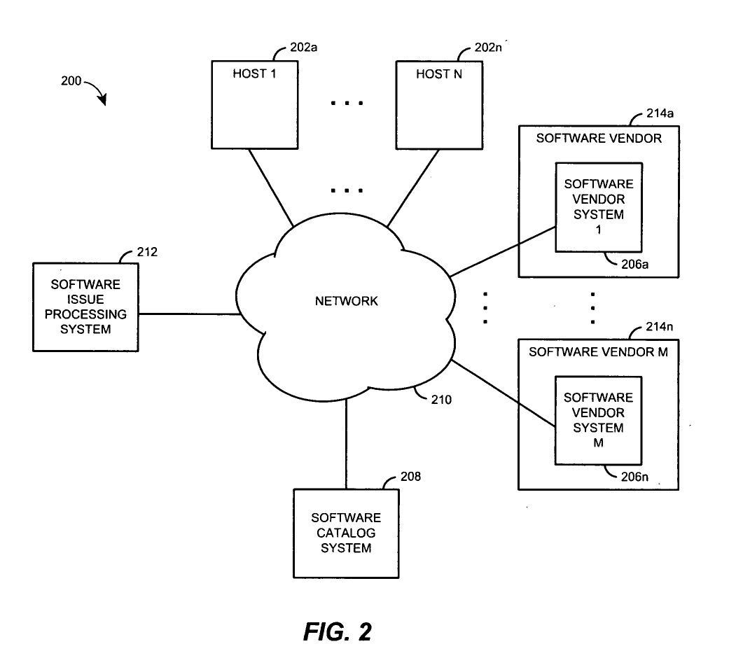

FIGS. 1A-1B provide a structural basis for the network and computational platforms related to the instant disclosure. In the figures, like reference numbers and designations in the various drawings indicate like elements. Furthermore, when individual elements are designated by references numbers in the form Nn, these elements may be referred to in the collective by N. For example, FIG. 2 illustrates hosts 202a-202n that may be referred to collectively as hosts 202

FIG. 1A illustrates a network 10. The network 10 may be the Internet, a virtual private network (VPN), or any other network that allows one or more computers, communication devices, databases, etc., to be communicatively connected to each other. The network 10 may be connected to a personal computer 12, and a computer terminal 14 via an Ethernet 16 and a router 18, and a landline 20. The Ethernet 16 may be a subnet of a larger Internet Protocol network. Other networked resources, such as projectors or printers (not depicted), may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. The network 10 may be useful for supporting peer-to-peer network traffic.

FIG. 1B illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1B illustrates operating system 134, application programs 135, other program modules 136, and program data 137.

The computer 110 may also include other removable/non-removable, volatile/nonvolatile computer storage media. By way of example only, FIG. 1B illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1B, provide storage of computer readable instructions, data structures, program modules and other data for the computer 110. In FIG. 1B, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163, such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1B. The logical connections depicted in FIG. 1B include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 1B illustrates remote application programs 185 as residing on memory device 181.

The communications connections 170, 172 allow the device to communicate with other devices. The communications connections 170, 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

FIG. 2 illustrates an example software issue management environment 200. Systems described in reference to FIG. 2 may be coupled to a network similar to the network 10 described in FIG. 1A. The systems described in reference to FIG. 2 may further include and/or be implemented on one or more computers similar to the computer 110 described in FIG. 1B.

Referring to FIG. 2, the software issue management environment 200 may include a number of hosts 202 that may run software developed and/or distributed by various software vendors 214. The software issue management environment 200 may further include one or more software catalog systems 208 that provide information about the various software and/or software vendors 214 (e.g., information related to common issues associated with particular applications). Still further, the software issue management environment 200 may include a software issue management system 212 that generally collects, aggregates, processes and distributes various information regarding issues associated with the different software (e.g., common errors, defects, and so on) and information regarding solutions for those issues.

As will be understood, the software issue management environment 200, in some embodiments, or in some modes of operation, may not include one or more of the units 202-214 described above or, alternatively, may not use each of these units 202-214. Likewise, the software issue management environment 200 may include additional units, not shown in FIG. 2 for ease of explanation. Furthermore, it will be appreciated that some of units 302-312 described in reference to FIG. 2 may be combined, or divided into distinct components. For example, although FIG. 2 illustrates the software issue management system 212 and the software catalog systems 208, in some embodiments, some or all of the functions of software catalog systems 208 may be integrated into, or otherwise performed by software issue management system 212. The various units 202-214 of the software issue management environment 200 illustrated in FIG. 2 will subsequently be described in more detail.

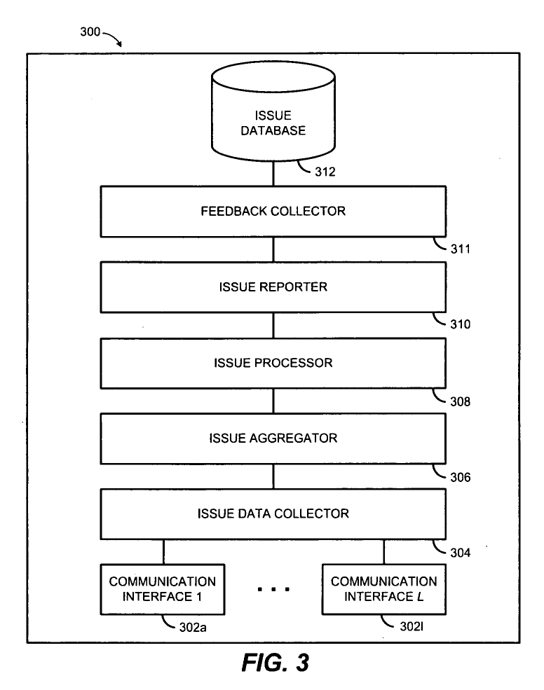

FIG. 3 is a block diagram of an example software issue management system 300 that may be generally used for managing software issues. The software issue management system 300 may be utilized in the software issue management environment 200 as the software issue management system 212. It will be understood, however, that the software issue management environment 200 may include another software issue management system 212. The software issue management system 300 may be coupled to a network similar to the network 10 described in FIG. 1A. The software issue management system 300 may further include and/or be implemented on one or more computers similar to the computer 110 described in FIG. 1B.

Referring to FIG. 3, the software issue management system 300 may include one or more communication interfaces 302 for exchanging data over a wired or wireless communication link with other systems. Such other systems may include the various systems illustrated in FIG. 2 (e.g., hosts 202, software vendor systems 206 of various software vendors 214 and software catalog systems 208).

The software issue management system 300 may also include an issue data collector 304 for collecting (e.g., via one or more of the communication interfaces 302) various information regarding issues associated with the different software provided by various software vendors. For example, the issue data collector 304 may collect information from different hosts (such as hosts 202 illustrated in FIG. 2) regarding different software crashes, errors, general defects, etc. In some embodiments, for instance, the issue collector 304 may receive such information from a given host when, or shortly after, the host experience one or more such issues (e.g., after a software crash, or during substandard software performance, and so on). This information may be sent by the host to the issue management system 300 automatically, e.g., in response to an issue, or a user may prompt the host to send that information to the issue management system 300. Additionally, or alternatively, the issue collector 304 may query a host for such information, for example, when the hosts are operating normally.

Optionally, the software issue management system 300 may also include an issue aggregator 306 for, generally speaking, aggregating and organizing the collected information regarding the issues related to the different software. In some embodiments, the issue aggregator 306 may aggregate, organize and store the collected information an issue database 312. The information may be organized in the issue database 312 in a variety of different ways. For example, the issue database 312 may include an entry associated with each different software application, and each entry may include information regarding issues associated with that particular application.

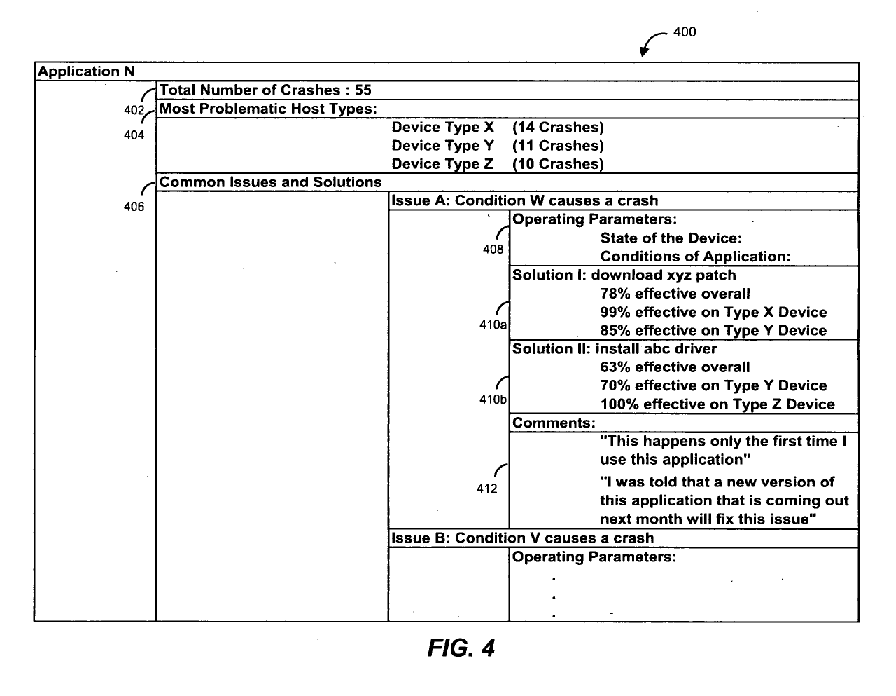

FIG. 4 illustrates an example issue database entry 400 for a given application (“Application N”). The issue database entry 400 for a given application may include, for example, information regarding the number of crashes associated with that application 402, e.g., as reported by various remote hosts. Additionally, the issue database entry 400 may include a list of host types (or devices) 404, that experience the most issues with the application. Further, the issue database entry 400 for a given application may include a list of common issues 406 experienced by the hosts that run that application. This list may include various operating parameters 408 associated with the different issues, such a the state of the host or the condition of the application before, and/or after the issue occurred, the version of the operating system, and so on. This list of common issues may also include a set of possible solutions 410 for fixing the issue. The set of possible solutions 410 may further include information regarding the effectiveness of the different solutions in different circumstances, on different host types, etc. Additionally, the issue database entry 400 for a given application may include generic comments 412 from various users, e.g., regarding the different issues, effectiveness of the available solutions, and so on. It will be appreciated by one of ordinary skill in the art that the database entry 400 for a given application may include various other information that is not specifically mentioned above.

Referring again to FIG. 3, the software issue management system 300 may further include an issue processor 308 for processing the collected issues, for example, to determine appropriate solutions for the issues. In some instances, determining a solution for a given issue may be involve looking up, e.g., in the issue database 312, the most effective, or otherwise most suitable, solution for a given host, a given set of operating parameters, etc. Additionally, or alternatively, in order to determine one or more suitable (or potentially suitable) solutions for a given issue, the issue processor 308 may interact with systems other than the issue management system 300, including systems similar to those illustrated in FIG. 2 (e.g., hosts 202, software vendor systems 206 of various software vendors 214 and software catalog systems 208). Mechanisms for processing an issue to determine a solution, or solutions for the issue will be subsequently described in more detail.

In some embodiments, the software issue management system 300 may additionally include an issue reporter 310 for distributing (e.g., via one or more communication interfaces 302) information regarding known issues and solutions to other systems, including, for example systems similar to those illustrated in FIG. 2 (e.g., hosts 202, software vendor systems 206 of various software vendors 214 and software catalog systems 208). For instance, the issue reporter 310 may provide particular hosts with information regarding solutions for specific issues that these hosts experience. Additionally, the issue reporter 310 may provide software vendors (e.g., via their software vendor systems) with information regarding issues specific to the software provided by these software vendors. The issue reporter 310 may distribute a wide range of other information to different systems, as will be subsequently described in more detail.

The software issue management system 300 may further include a feedback data collector 311 for collecting feedback regarding the effectiveness of the different solutions. For example, after the issue reporter 310 provides a particular host with information regarding a potential solution for a given issue, the feedback data collector 311 may collect feedback from the host regarding the effectiveness of the provided issue. If the feedback from the host indicates that the solution was effective, the issue management system 300 may provide the same, or similar solution to other hosts if those hosts experience the same, or similar issues in the future.

It should be understood that the software issue management system 300, in some embodiments, or in some modes of operation, may not include one or more of the components 302-312 described above or, alternatively, may not use each of these components 302-312. Likewise, the software issue management system 300 may include additional components, not shown in FIG. 3 for ease of explanation. Further, it will be appreciated that some of components 302-312 described in reference to FIG. 3 may be combined, or divided into distinct components.

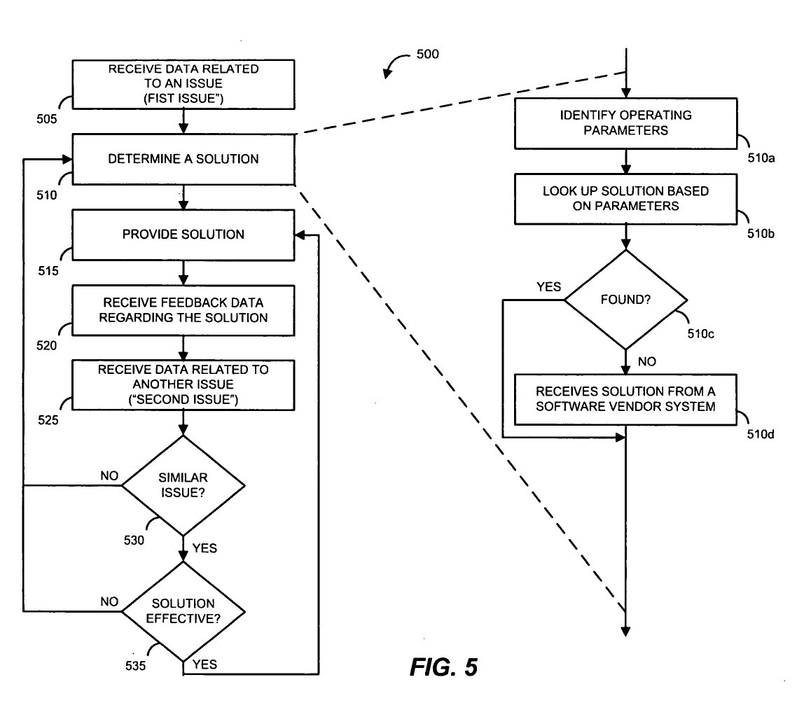

FIG. 5 is a flow diagram of an example method 500 for managing software issues that may be performed, for example, by a software issue management system such as the software issue management system 300 described in reference to FIG. 3. For ease of explanation, FIG. 5 will be described with reference to FIGS. 1-4. It will be understood, however, that the method 500 from managing software issues may be utilized with systems and devices other than those illustrated in FIGS. 1-4.

The software issue management system, such as the software issue management system 300 illustrated in FIG. 3, may use an issue data collector to receive, e.g., via one or more of the communication interfaces, data related to a software issue (“first software issue”) experienced by a host and associated with a particular software application (block 505). A software issue may include, for example, a crash, an error, a defect, and so on. The received data associated with the software issue may identify various operational parameters associated with the issue, such as various attributes of the host, the state of host before or after the occurrence of the issue, one or more conditions of the application before or after the occurrence of the issue, and so on. Attributes of the host may include the type of the host (e.g., make and model of the device), hardware capabilities of the host, presence or absence of particular resources (e.g., a camera, or a Bluetooth interface), etc. Data about the state of the host may include information about the host's general networking environment (e.g., whether the host is operating in the general packet radio service (GPRS) environment, Enhanced Data rates for GSM Evolution (EDGE) environment, WiFi environment, and so on). Information about conditions of the application may include application version number, type and version of the operating system, whether the application was in sleep mode, in boot-up state, etc. when the issue occurred, and so on.

The data related to the software issue may be received in a variety of ways. For example, the host experiencing the issue may automatically send such data to the software issue management system when the issue (e.g., a crash) occurs. Additionally, or alternatively, a user of the host may manually send such information to the software issue management system if, for example, the use observes that the performance of the application at issue is not satisfactory (e.g., too slow).

The data related to the software issue may be received in a variety of different formats. For example, the host experiencing the issue may send a partial, or a full, memory dump to the software issue management system. This memory dump may include, for example, machine stack data, call stack data, global object tree, trace information, and so on. Data in the memory dump may generally be indicative of any information related to the various operational parameters associated with the software issue, as discussed above. In addition to, or instead of, the memory dump, a user of the host may manually send information regarding the issue. Such information may include, for example, natural-language comments describing the issue (e.g., “device locks up when camera is in use”). Additionally, or alternatively, the user may send information regarding an issue in some sort of a standard format (e.g., in a form of a response to a question, or a series of questions from the software issue management system)

Once data associated with the first software issue is received (block 505), the software issue management system may use the issue processor to automatically determine a solution for the issue (block 510). The solution for the issue may be determined in a number of ways. For example, the software issue management system may identify the operating parameters associated with the issue (block 510a), as discussed above, and look up, for example, in a database, such as the database 400 illustrated in FIG. 4, a potential solution that is associated with the identified operating parameters (block 510b). For example, referring to FIG. 4, if the software issue management system identifies the received first issue as Issue A associate with Application N that is running on a device of type Z, the software issue management system may suggest Solution II. More generally, if a solution is found after such, or a similar lookup (branch “YES” of block 510c), the software issue management system may use that solution to further process the first software issue.

If a solution is not found (“NO” branch of block 510c), the software issue management system may query a software vendor system of the software vendor associated with the software application at issue for a solution. As part of that query, the software issue management system may forward some, or all of the data related to the issue that was received from the host to the corresponding software vendor system. As a result of the query, the software issue management system may receive the solution from the corresponding software vendor system (block 510d).

Once the solution is determined (block 510), the software issue management system may us the issue reporter to, generally speaking, provide data associated with the solution to the host at issue (block 515). The solution (or data associated therewith) may be provided from the software issue management system, or from a software vendor (via the software issue management system, or, in some embodiments, directly), to the host at issue in a variety of ways. For example, the software issue management system may send an executable file (e.g., a patch) to the host at issue that, when executed, fixes, or otherwise addresses the issue. The software issue management system may also send a reference (e.g., a link) to a location (e.g., a remote server) from which such an executable file, or any other form of the solution may be downloaded. It will be appreciated that various other types of files other than executable files (e.g., DLL file, configuration files, and so on) may be provided as a potential solution. Also, instead of, or in addition to some sort of a file, or a link thereto, the software issue management system may provide the host with a set of instructions on how to fix the issue.

After the software issue management system sends, or otherwise provides a solution, or data related thereto, to the host (block 515), the software issue management system may use the feedback collector to receive feedback from the host regarding the effectiveness of the solution (block 520). For example, the software issue management system may request that the user of the host rate the effectiveness of the solution, e.g., as effective, or not effective, or from 1 to 10. The software issue management system may also request that the user provide verbal comments regarding the effectiveness of the solution (e.g., “solution fixed the problem, but the problem reappeared after a reboot”).

If the user indicates that the solution was effective in fixing the issue (e.g., if the effectiveness rating provided by the user exceeds a predefined threshold), the solution may be used in the future to fix similar issues. For example, the software issue management system, at some point in the future, may receive data related to another software issue (“second software issue”) from a different host (block 525). When the second software issue is received, the software issue management system may determine that the second software issue is sufficiently similar to the first software issue, e.g., the operating parameters associated with the first issue and the operating parameters associated with the second issue include one or more common parameters (“YES” branch block 530). If that is the case, and if the solution that was determined for the first issued was found to be sufficiently effective (“YES” branch of block 535), the same solution may be provided to the second host for fixing the second issue. Alternatively, for example if the second issue is not sufficiently similar to the first issue (“NO” branch of block 530), or the solution provided for the first issue did not receive positive feedback (“NO” branch of block 535), the software issue management system may determine the solution for the second issue separately from the first issue.

The software issue management system 300 discussed in reference to FIGS. 3-4 and the method 500 for managing software issues discussed in reference to FIG. 5 provide a number of important advantages. Typically, software vendors develop software for different types to hosts without necessarily knowing the characteristics of all the possible types of hosts that will be running that software. This is especially the case when software vendors develops software mobile devices, of which there is a large variety. The issue management system discussed above effectively provides an environment for the software vendors to test their software on different types of hosts (including hosts that the software vendors may not be aware of or have not been made available to developers). This allows the software vendors to identify common issues with their software, to pinpoint particular issues associated with specific types of hosts, with specific types of operating conditions, and so on.

In particular, the disclosed software issue management system allows software vendors to spot recurring software issues (e.g., software issues that always occur on particular types of hosts, or under particular operating conditions). For instance, users may experience certain issues on hosts that lack particular hardware (e.g., a camera, or a Bluetooth interface). The disclosed software issue management system may detect such patterns and allow software vendors to fix problems with their software (particularly recurring problems). Furthermore, because the disclosed software issue management system allows users to provide feedback on the effectiveness of the determined solutions, the software issue management system may allow software vendors to fix problems with their software in a more efficient manner.

Some, or all of the functionality described above in reference to FIGS. 3-5 may be implemented by a single software issue management system, such as the software issue management system 300 described in reference to FIG. 5. However, some of this functionality may be offloaded other devices. In particular, some of the data regarding the different applications, issues associated with those applications, solutions associated with those issues, etc. may be stored in a software catalog system, such as the software catalog system 208 illustrated in FIG. 2.

Referring again to FIG. 2, in some embodiments, different software vendors may upload their software applications to the software catalog system 208 to be used (e.g., downloaded and executed) by the various hosts 202. In addition to providing the software applications themselves, the software catalog system 208 may include various metadata about the software applications that are available to the hosts 202. This metadata may include, for instance, information related to the different software issues associated with the different software applications, such as the information shown in FIG. 4 (e.g., number of reported crashes for a given application, types of hosts that experience the most problems with the application, common issues associated with the application, potential solutions for those issues, and so on). This metadata may also include qualitative information, such as comments from different users.

As a result, users of different of hosts, or devices, may use the software catalog system 208, and, more particularly, the metadata in the software catalog system 208, to determine which applications to download, for example and not limitation, to minimize the number of software issues, how to fix software issues if they do arise, which software applications to use on which hosts, and so on. For example, if a certain application tends to crash frequently on particular types of hosts (e.g., hosts that lack a Bluetooth communication interface), users of such hosts may be alerted to this problem via the software catalog system and not download and/or use that application. Moreover, in addition to, or instead of, providing feedback to the software issue management system 212 (as described, for instance, in reference to FIG. 5), hosts may provide feedback regarding, for example, effectiveness of different solutions for different issues to the software catalog system 208. Consequently, if a user of a given host decides to use a particular application that has a high crash rate on other hosts of that type, that user may use the software catalog system and all the feedback therein from other users, for the purposes of debugging and fixing such, or similar crashes.

In some embodiments, the software catalog system 208 may have a policy mechanism associated with it such that any combination of elements such as the number of crashes, time between unique crash instances, user feedback/ratings, solution effectiveness, etc. may impact the way software applications are presented (e.g., displayed) to users. For example, different software applications may be presented to users in a particular order, based on how well these software applications generally perform. A software application with a relatively small number of crashes within a relatively long period of time may be presented to users before a software application with a relatively large number of crashes within a relatively short period of time. Additionally, or alternatively, the policy mechanism may control which software applications are presented at all. For example, if a certain software application exceeds a certain (e.g., predefined) crash rate, this software application might not be presented to users at all.

In order for a host to communicate with the software issue management system, or with a software catalog system, after a software issue has occurred, the host may be configured so that a software issue, when it occurs, does not disable to host's ability to communicate with the network. Accordingly, in order to communicate data related to software issues, a host may include a virtual machine (VM) that is largely separate from other functionality of the host.

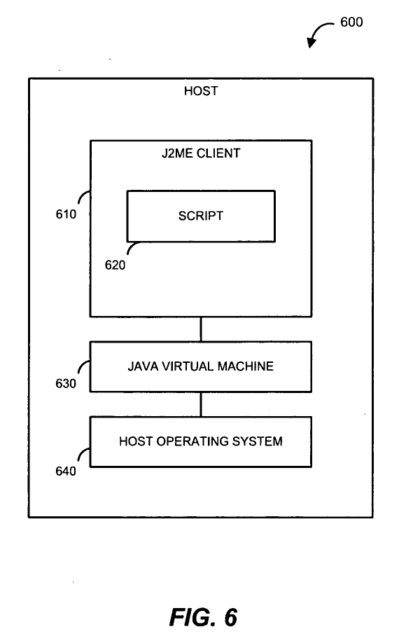

FIG. 6 is a block diagram of an example host 600 that includes a virtual machine. In some embodiments particular, the host 600 may include a Java 2 Micro Edition (J2ME) client 610 running on top of a Java Virtual Machine (JVM) 630 in a mobile phone. Such a host may provide a separate execution environment that is a Java applet, within which various scripts may run. The various software applications discussed about in reference to FIGS. 1-5 may take the form of such scripts.

As illustrated in FIG. 6, this configuration may provide a separate execution environment. As a result, software issues (particularly crashes) may be contained without crashing the entire host. In turn, the J2ME client may host a separate VM in which applet scripts may run, thus being able to contain and report crashes (e.g., communicate crashes to the software issue management system. Script halts (e.g., uncaught user- or framework-level exceptions) and VM exceptions may be caught and, while the applet itself may be left in an inconsistent state, the host may remain in a consistent state, and it may be able to communicated with the software issue management system, or with a software catalog system, and gather information regarding solutions for various software issues. It will be understood that computing devices discussed herein may utilize other technologies beyond a virtual machine. Such technologies may include an independent embedded processor that can communicate the state of memory registers to a crash data collection server independent of the operating system or application state, or an operating system that employs strict process isolation such that a crash collection process may be able to collect feedback from the user regarding the crash or attempted fix.

Although the forgoing text sets forth a detailed description of numerous different embodiments, it should be understood that the scope of the patent is defined by the words of the claims set forth at the end of this patent. The detailed description is to be construed as providing examples and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A computer program product, comprising a computer usable medium having a computer-readable program code embodied therein, the computer-readable program code adapted to be executed to implement a method of managing software issues on multiple hosts, the method comprising:
receiving first issue data related to a first software issue with a software application installed on a first remote host, wherein the first issue data identifies one or more operating parameters associated with the first software issue;
determining a solution for the first software issue;
providing solution data related to the determined solution for the first software issue to the first remote host;
receiving feedback data from the first remote host, wherein the feedback data indicates whether the determined solution was effective in fixing the first software issue;
receiving second issue data related to a second software issue with the software application installed on a second remote host, wherein the first issue data identifies one or more operating parameters associated with the second software issue; and
providing the solution data to the second remote host if:
the one or more operating parameters associated with the first software issue and the one or more operating parameters associated with the second software issue include at least one common operating parameter; and
the feedback data from the first remote host indicates that the determined solution was effective in fixing the first software issue.

2. The computer program product of claim 1, wherein the first issue data includes at least a partial memory dump of the first remote host identifying the one or more operating parameters associated with the first software issue, and wherein the second issue data includes at least a partial memory dump of the second remote host identifying the one or more operating parameters associated with the second software issue.

3. The computer program product of claim 2, wherein the one or more operating parameters associated with the first software issue includes one or more attributes of the first remote host, and wherein the one or more operating parameters associated with the second software issue includes one or more attributes of the second remote host.

4. The computer program product of claim 3, wherein the one or more operating parameters associated with the first software issue includes one or more conditions of the software application on the first remote host, and wherein the one or more operating parameters associated with the second software issue includes one or more conditions of the software application on the second remote host.

5. The computer program product of claim 1, wherein determining the determined solution for the first software issue comprises querying a software vendor system of a software vendor of the software application.

6. The computer program product of claim 1, wherein at least one of the first remote host and the second remote host is a mobile phone.

7. The computer program product of claim 6, wherein the mobile phone include a Java 2 Micro Edition (J2ME) client running on top of a Java Virtual Machine.

8. The computer program product of claim 7, wherein the J2ME client is configured to contain a crash, and wherein at least one of the first issue data and the second issue data is data related to the crash.

9. A system comprising:
a software issue processing system having a computer-readable program code embodied therein, the computer-readable program code adapted to be executed on a processor to:
receive issue data from a plurality of remote hosts, wherein the issue data is related to a plurality of issues associated with a software application installed on each the plurality of remote hosts;
identify a common issue among the plurality of issues, wherein the common issue is associated with a subset of the plurality of remote hosts of a particular host type; and
associate the common issue with the particular host type; and
a software catalog system having a computer-readable program code embodied therein, the computer-readable program code adapted to be executed on the processor to provide a user with information regarding the common issue and the particular host type.

10. The system of claim 9, wherein the software issue processing system has computer-readable program code further adapted to be executed on the processor to identify a potential solution for the common issue.

11. The system of claim 9, wherein the software issue processing system has computer-readable program code further adapted to be executed on the processor to associating the potential solution with the common issue.

12. The system of claim 9, wherein the software issue processing system has computer-readable program code further adapted to be executed on the processor to send solution data to at least one the subset of the plurality of remote hosts of the particular host type, wherein the solution data is indicative of the identified potential solution.

13. The system of claim 9, wherein the software issue processing system has computer-readable program code further adapted to be executed on the processor to receiving feedback data from the at least one the subset of the plurality of remote hosts of the particular host type, wherein the feedback data is indicative of an effectiveness of the identified potential solution for the common issue.

14. The system of claim 9, wherein the software issue processing system has computer-readable program code further adapted to be executed on the processor to associating the effectiveness of the identified potential solution with the identified potential solution.

15. The system of claim 9, wherein the software catalog system has computer-readable program code further adapted to be executed on the processor to provide a user with information regarding the identified potential solution with the identified potential solution.

16. A computer program product, comprising a computer usable medium having a computer-readable program code embodied therein, the computer-readable program code adapted to be executed to implement a method of managing software issues on multiple hosts, the method comprising:
receiving issue data from a remote host, wherein the issue data is related to an issue associated with a software application installed on the remote host;
identifying a potential solution for the issue;
sending solution data to the remote host, wherein the solution data is related to the identified potential solution; and
receiving feedback data from the remote host, wherein the feedback data is indicative of a degree to which the identified potential solution was effective in resolving the issue.

17. The computer program product of claim 16, wherein the remote host is a mobile phone.

18. The computer program product of claim 16, wherein the issue data is at least a partial memory dump of the remote host.

19. The computer program product of claim 18, wherein the at least the partial memory dump of the remote host includes one or more attributes of the remote host or one or more conditions of the software application.

20. The computer program product of claim 18, wherein the issue data is first issue data and the issue is a first issue, the method further comprising:
receiving second issue data from the remote host, wherein the second issue data is related to a second issue associated with the software application installed on the remote host; and
sending the solution data to the remote host.
